(19) United States
(12) Patent Application Publication
(10) Pub. No.: US 2008/0159101 A1
(43) Pub. Date: Jul. 3, 2008

(54) OPTICAL DISK DEVICE AND CONTROL METHOD THEREOF

(75) Inventors: Masahiro Saito, Yokohama-shi (JP); Kazuto Kuroda, Yokohama-shi (JP); Takashi Usui, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/840,716

(22) Filed: Aug. 17, 2007

(30) Foreign Application Priority Data
Dec. 28, 2006 (JP) 2006-356483

(51) Int. Cl. G11B 7/00

(52) U.S. Cl. 369/53.19

(57) ABSTRACT

Disclosed is an optical disk device including: an objective lens unit having an objective lens and a lens holder; an elastic supporting member supporting displaceably the objective lens unit on a body of an optical head; first and second drive sections applying respectively driving forces to first and second driven positions on the objective lens unit opposed across a position of a center of mass of the objective lens unit in a direction orthogonal to an optical axis of the objective lens; and a driving force adjustment section adjusting allocation of the driving forces respectively applied to the first and second driven positions so that a possible influence of a displacement force in a tilt direction on a displacement force in a focusing direction at the position of the center of mass when the displacement forces act on the objective lens unit is avoided.

### CROSS-REFERENCE TO RELATED APPLICATIONS

This application is based upon and claims the benefit of priority from the prior Japanese Patent Application No. 2006-356483, filed on Dec. 28, 2006; the entire contents of which are incorporated herein by reference.

### BACKGROUND

1. Field of the Invention

The present invention relates to an optical disk device which reproduces or records information using an optical disk and a control method thereof.

2. Description of the Related Art

An optical disk device in which tilt correction of an objective lens as well as focus control of the objective lens is performed by feedforward control using two kinds of focus coils provided in a drive mechanism of the objective lens on an optical head is known (for example, see Patent Reference 1).

Further, an optical disk device in which an improvement is added to tilt control of an objective lens by correcting a current value to be supplied to two focus coils in a form that reflects a difference between tilt detection values in the objective lens detected at different radial positions on an optical disk is proposed (for example, see Patent Reference 2).

[Patent Reference 1] JP-A 2005-521985 (KOHYO)

[Patent Reference 2] JP-A 2003-272203 (KOKAI)

However, the techniques of the above respective documents have difficulty in properly drive-controlling the objective lens since control in a tilt direction and control in a focusing direction of the objective lens interfere with each other.

### SUMMARY

Hence, the present invention has been made to solve the above problem and has as its object to provide an optical disk device capable of realizing suitable drive control of an objective lens while suppressing mutual interference between tilt control and focus control of the objective lens on an optical head and a control method thereof.

An optical disk device according to an aspect of the present invention comprises: an objective lens unit in which an objective lens and a lens holder are integrated; an elastic supporting member which displaceably supports the objective lens unit on a body of an optical head; first and second drive sections which apply, respectively, driving forces to first and second driven positions on the objective lens unit opposed across a position of a center of mass of the objective lens unit supported by the elastic supporting member in a direction orthogonal to an optical axis of the objective lens; and a driving force adjustment section which adjusts allocation of the driving forces applied respectively to the first and second driven positions by the first and second drive sections.

Further, a control method of an optical disk device according to an aspect of the present invention comprises: setting driving forces respectively to be applied to a first and second driven positions on an objective lens unit opposed across a position of a center of mass of the objective lens unit including an objective lens displaceably supported on a body of an optical head in a direction orthogonal to an optical axis of the objective lens; adjusting allocation of the set driving forces; and applying the driving forces the allocation of which is adjusted to the first and second driven positions, respectively.

According to the present invention, the optical disk device capable of realizing the suitable drive control of the objective lens while suppressing the mutual interference between the tilt control and the focus control of the objective lens on the optical head and the control method thereof can be provided.

### BRIEF DESCRIPTION OF THE DRAWINGS

FIG. 1 is a block diagram functionally showing the configuration of an optical disk device according to a first embodiment of the present invention.

FIG. 2 is a diagram schematically showing the structure of an optical head mounted in the optical disk device shown in FIG. 1.

FIG. 3 is a block diagram functionally showing the configurations of a focus/tilt control circuit and a first and second driving force generation circuits included in the optical disk device shown in FIG. 1.

FIG. 4 is a flowchart showing processing performed in the focus/tilt control circuit and the first and second driving force generation circuits shown in FIG. 3.

FIG. 5 is a block diagram functionally showing the configurations of a focus/tilt control circuit and a first and second driving force generation circuits included in an optical disk device according to a second embodiment of the present invention.

FIG. 6 is a graph showing the transition of a current imbalance amount between drive currents outputted from the first and second driving force generation circuits shown in FIG. 5.

FIG. 7 is a flowchart showing processing performed in the focus/tilt control circuit and the first and second driving force generation circuits shown in FIG. 5.

FIG. 8 is a block diagram functionally showing the configurations of a focus/tilt control circuit and a first and second driving force generation circuits included in an optical disk device according to a third embodiment of the present invention.

FIG. 9 is a flowchart showing processing performed in the focus/tilt control circuit and the first and second driving force generation circuits shown in FIG. 8.

FIG. 10 is a block diagram functionally showing the configuration of an optical disk device according to a fourth embodiment of the present invention.

FIG. 11 is a block diagram functionally showing the configurations of a focus/tilt control circuit and a first and second driving force generation circuits included in the optical disk device shown in FIG. 10.

FIG. 12 is a diagram to explain measurement items of characteristic parameters of a first and second drive current circuits included in the optical disk device shown in FIG. 10.

FIG. 13 is a flowchart showing processing on measurement of a characteristic of the first drive current circuit included in the optical disk device shown in FIG. 10 and registration of results of the measurement.

FIG. 14 is a flowchart showing processing on measurement of a characteristic of the second drive current circuit included in the optical disk device shown in FIG. 10 and registration of results of the measurement.

FIG. 15 is a flowchart showing operation control to correct the characteristics of the first and second drive current circuits when the optical disk device shown in FIG. 10 is used.

### DETAILED DESCRIPTION

### Description of Embodiments

Embodiments of the present invention will be described with reference to the drawings, but the drawings are presented only for illustrative purpose and do not limit the invention in any way.

The best mode for carrying out the present invention will be described below with reference to the drawings.

### First Embodiment

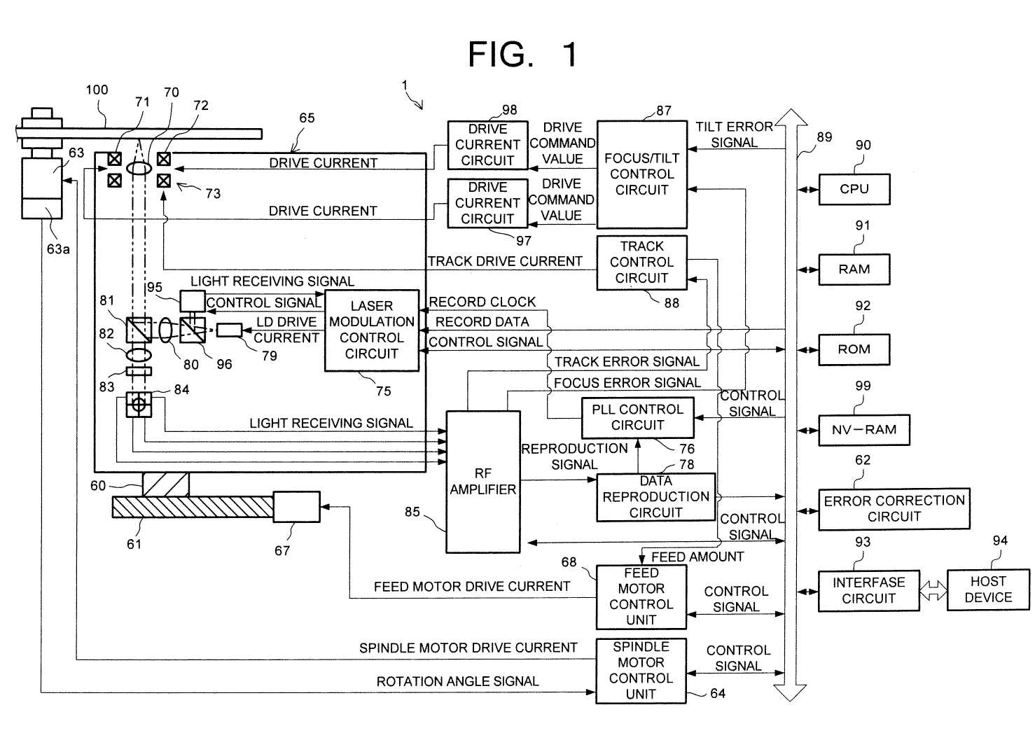

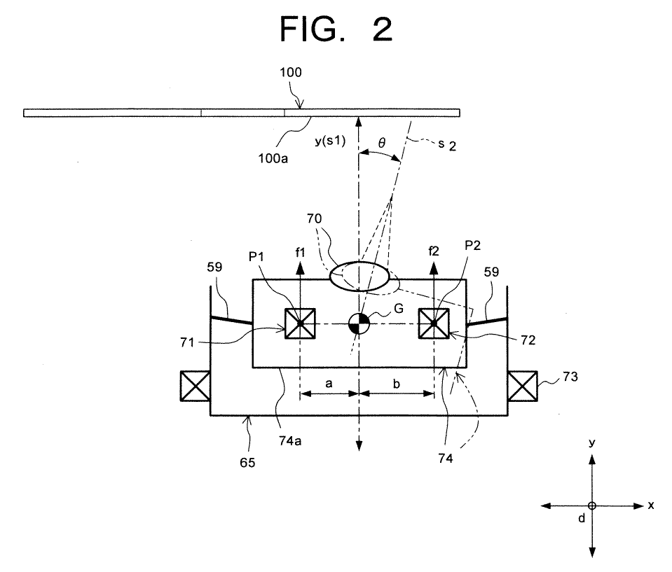

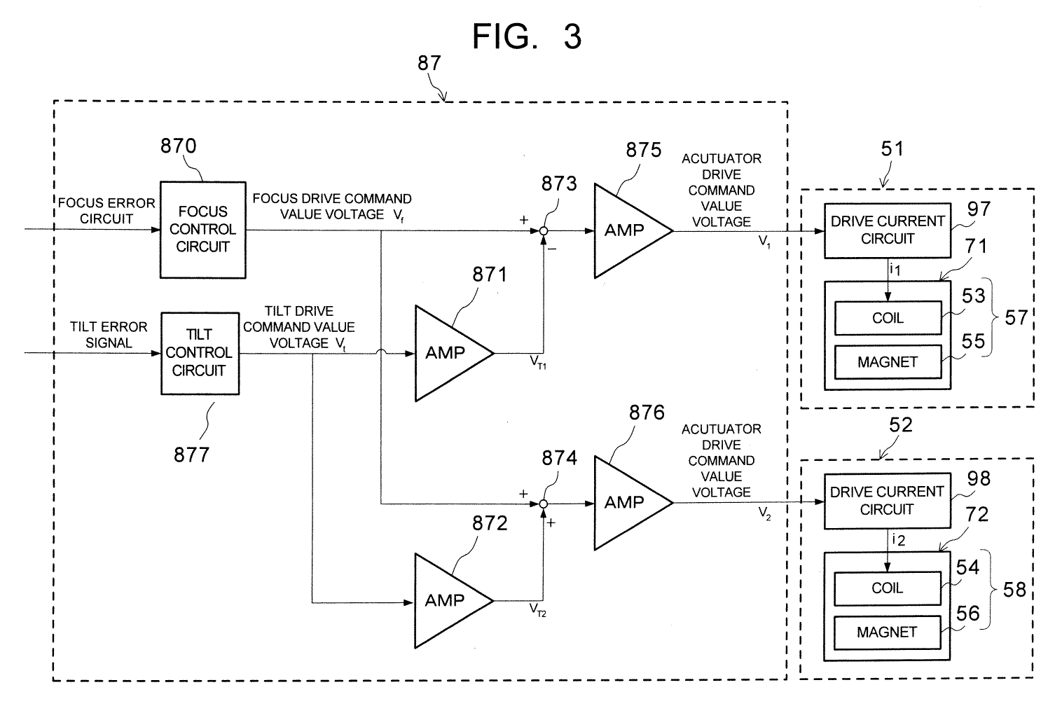

FIG. 1 is a block diagram functionally showing the configuration of an optical disk device 1 according to a first embodiment of the present invention. Further, FIG. 2 is a diagram schematically showing the structure of an optical head 65 mounted in this optical disk device 1. Furthermore, FIG. 3 is a block diagram functionally showing the configurations of a focus/tilt control circuit 87 and a first and second driving force generation circuits 51 and 52 included in the optical disk device 1.

As shown in FIG. 1 and FIG. 3, the optical disk device 1 of this embodiment mainly includes an optical head 65, a spindle motor 63, a feed motor 67, a spindle motor control circuit 64, a feed motor control circuit 68, an RF amplifier 85, a PLL control circuit 76, a data reproduction circuit 78, a track control circuit 88, the focus/tilt control circuit 87, the first and second driving force generation circuits 51 and 52, a signal bus 89, a CPU 90, a RAM 91, a ROM 92, an NV-RAM 99, an error correction circuit 62, and so on. Such an optical disk device 1 is connected to a host device 94 via a predetermined interface circuit 93.

Namely, the optical disk device 1 reproduces and/or records information using an optical disk 100 such as a DVD (Digital Versatile Disc) as an information storage medium. In the optical disk 100, an information recording surface 100a shown in FIG. 2 is concentrically or spirally grooved. A recessed portion of such a groove of the optical disk 100 is called a groove, a projecting portion thereof is called a land, and one circle of groove or land is called a track. Information on user data is recorded by irradiating laser light whose intensity is modulated along this track (only the groove or the groove and the land) to form a record mark.

Data is reproduced by irradiating laser light with weaker read power than in recording along the track to detect a change in reflected light intensity caused by the record mark on the track. Recorded data is erased by irradiating laser light with erase power stronger than the above read power along the track to crystallize a recording layer.

As shown in FIG. 1, the optical disk 100 is rotationally driven by the spindle motor 63 which functions as a disk rotation drive section. A rotation angle signal is obtained from a rotary encoder 63a provided in the spindle motor 63. The rotation angle signal generates, for example, a 5-pulse pulse signal if the spindle motor 63 makes one rotation. The rotation angle and rotation frequency of the spindle motor 63 can be detected from this rotation angle signal.

Further, as shown in FIG. 1 and FIG. 2, the above optical head 65 is constituted of an objective lens 70, an objective lens unit 74, a first to third actuators 71, 72, and 73, a laser diode 79, a laser modulation control circuit 75, a half mirror 96, an FM-PD 95, a collimator lens 80, a half prism 81, a condenser lens 82, a cylindrical lens 83, a photodetector 84, and so on.

That is to say, information is recorded on and reproduced from the optical disk 100 by the optical head (optical pickup) 65. The optical head 65 is coupled to the feed motor 67 via a gear 60 and a screw shaft 61. This feed motor 67 is driven by the feed motor control circuit 68. Namely, by rotating the feed motor 67 by a feed motor driving current from the feed motor control circuit 68, the optical head 65 moves in a radial direction of the optical disk 100.

As shown in FIG. 2, the optical head 65 is provided with the objective lens unit 74 in which the above objective lens 70 and a lens holder 74a holding this objective lens 70 are integrated. The objective lens unit 74 is displaceably supported on a body (head base) of the optical head 65 via an elastically deformable elastic supporting member 59 such as a suspension wire or a leaf spring.

Here, the above first and second driving force generation circuits 51 and 52 which function as a first and second drive sections respectively include a first and second actuators 71 and 72 respectively having a first and second magnetic circuits 57 and 58 and a first and second drive current circuits 97 and 98 as shown in FIG. 1 to FIG. 3. The first and second drive current circuit 97 and 98 output drive currents with values corresponding to voltage values of inputted signals. The first and second actuators 71 and 72 generate driving forces corresponding to the values of the drive currents respectively outputted from the first and second drive current circuits 97 and 98.

Namely, as shown in FIG. 3, the above actuators 71 and 72 constitute the first and second magnetic circuits 57 and 58 by magnets 55 and 56 and coils 53 and 54 for magnetic drive and generate driving forces to drive the objective lens unit 74 in predetermined directions by Lorentz forces which are generated by supplying the drive currents from the first and second drive current circuits 97 and 98 to the above coils 53 and 54. Likewise, the third actuator 73 also includes a magnetic circuit constituted of a magnet and a coil for magnetic drive.

To put it in detail, as shown in FIG. 1 to FIG. 3, the first and second driving force generation circuits 51 and 52 including the above actuators 71 and 72 respectively apply driving forces to a first and second driven positions P1 and P2 on the objective lens unit 74 which are opposed across a position of a center of mass G of the objective lens unit 74 supported by the elastic supporting member 59 in a direction (radial direction in this embodiment) x orthogonal to an optical axis s1 of the objective lens.

That is to say, as shown in FIG. 2 and FIG. 3, the first and second drive current circuits 97 and 98 supply drive currents, for example, whose current values are equal to each other, to the respective coils 53 and 54 of the magnetic circuits 57 and 58, which makes it possible to move the objective lens unit 74 (objective lens 70) on the optical head 65 in a focusing direction y along the optical axis s1 of the objective lens 70 as shown in FIG. 2. On the other hand, the first and second drive current circuits 97 and 98 supply drive currents, for example, whose current values are different from each other, to the respective coils 53 and 54 of the magnetic circuits 57 and 58, which makes it possible to drive the objective lens unit 74 (objective lens 70) also in a tilt direction θ being a direction in which the optical axis s1 of the objective lens 70 tilts with respect to the information recording surface 100a of the optical disk (a direction in which like an optical axis s2, the optical axis s1 tilts). Further, by supplying a predetermined drive current to the coil for drive of the magnetic circuit included in the actuator 73, it is possible to move the objective lens unit 74 in the tracking direction (radial direction) x along the radial direction of the optical disk 100. Incidentally, θ in FIG. 2 represents a displacement angle between the optical axis s2 of the objective lens 70 and the focusing direction y as seen from a tangential direction d.

Here, as shown in FIG. 2, the optical head 65 of this embodiment has the structure in which the driving forces in the focusing direction y are applied from the first and second driven positions P1 and P2 which are opposed across the position of the center of mass G of the objective lens unit 74 in the radial direction x. Therefore, the tilt direction of the objective lens 70 whose movement is controllable by the actuators 71 and 72 is a radial tilt direction. Here, instead of the actuators 71 and 72, for example, a pair of actuators which are placed so as to apply driving forces in the focusing direction y from two driven positions opposed across the position of the center of mass G of the objective lens unit 74 in the tangential direction d may be provided. The tilt direction of the controllable objective lens 70 in this case is a tangential tilt direction. Further, by placing a pair of actuators at intermediate positions therebetween, an optical head capable of drive-controlling the objective lens 70 both in the radial tilt direction and the tangential tilt direction may be constituted.

The laser modulation control circuit 75 supplies a writing signal to the laser diode (laser light emitting element) 79 based on record data transmitted from the host device 94 via the interface circuit 93 when information is recorded (when a record mark is formed). Further, the laser modulation control circuit 75 supplies a reading signal (having a smaller drive current than the above writing signal) to the laser diode 79 when information is read.

The optical head 65 includes the FM-PD 95 constituted of a photodiode. The FM-PD 95 causes part of laser light generated by the laser diode 79 to branch off by a certain percentage by the half mirror 96, detects a light receiving signal proportional to light amount, that is, irradiation power, and supplies this light receiving signal to the laser modulation control circuit 75. Based on the light receiving signal from the FM-PD 95, the laser modulation control circuit 75 controls the laser diode 79 in such a manner that the laser light is emitted with laser power suitable for reproduction, recording, and data erase respectively set by the CPU 90.

The laser diode 79 generates the laser light in response to the signal supplied from the laser modulation control circuit 75. The laser light generated from the laser diode 79 is irradiated onto the optical disk 100 via the collimator lens 80, the half prism 81, and the objective lens 70. Reflected light from the optical disk 100 is guided to the photodetector 84 via the objective lens 70, the half prism 81, the condenser lens 82, and the cylindrical lens 83.

The photodetector 84 is constituted, for example, of four divided photodetection cells, and detection signals of these photodetection cells are outputted to the RF amplifier 85. The RF amplifier 85 processes the signals from the photodetection cells and generates a focus error signal indicating an error from a just focus, a tracking error signal indicating an error between a beam spot center of the laser light and a track center, and a reproduction signal being a fully added signal of the photodetection cell signals. That is to say, as shown in FIG. 1 and FIG. 2, the RF amplifier 85 has a function as a focus error signal output circuit which outputs the focus error signal indicating a positional displacement in the focusing direction between the information recording surface 100a of the optical disk 100 rotationally driven by the spindle motor 63 and a focus position of the objective lens 70 on the optical head 65.

The focus error signal is supplied to the focus/tilt control circuit 87. As shown in FIG. 2, the focus/tilt control circuit 87 generates a focus drive signal with a value corresponding to a correction amount to correct the positional displacement in the focusing direction between the information recording surface 100a of the optical disk 100 rotationally driven by the spindle motor 63 and the focus position of the above objective lens on the optical head. This focus drive signal is supplied to the driving force generation circuits 51 and 52 to drive the objective lens unit 74 on the optical head 65, and thereby focus servo in which the laser light is always just focused onto a recording film of the information recording surface 100a of the optical disk 100 is performed.

Further, as shown in FIG. 1 and FIG. 3, the CPU 90 supplies a later-described tilt error signal to the focus/tilt control circuit 87 via the signal bus 89 in order to correct the objective lens 70. The focus/tilt control circuit 87 supplies a drive signal obtained by adding a later-described tilt drive signal to the focus drive signal to each of the driving force generation circuits 51 and 52.

The tracking error signal is supplied to the track control circuit 88. The track control circuit 88 generates a track drive signal in response to the tracking error signal. The track drive signal (track drive current) outputted from the track control circuit 88 is supplied to the third actuator 73 side. Consequently, tracking servo in which the laser light always traces tracks formed on the optical disk 100 is performed.

By performing the above focus servo and tracking servo, changes in reflected light from pits and the like formed on tracks of the optical disk 100 according to recording information are reflected in the fully added signal of the output signals of the respective photodetection cells of the photodetector 84. This signal is supplied to the data reproduction circuit 78. The data reproduction circuit 78 reproduces record data based on a reproducing clock signal from the PLL control circuit 76.

When the objective lens 70 is controlled by the above track control circuit 88, the feed motor 67, that is, the optical head 65 is controlled by the feed motor control circuit 68 so that the objective lens 70 is located near a predetermined position within the optical head 65.

Further, the spindle motor control circuit 64, the feed motor control circuit 68, the laser modulation control circuit 75, the PLL control circuit 76, the data reproduction circuit 78, the focus/tilt control circuit 87, the track control circuit 88, the error correction circuit 62, and so on are controlled by the CPU 90 via the signal bus 89. The CPU 90 overall controls the body of the optical disk device 1 in accordance with an operation command provided from the host device 94 via the interface circuit 93. Further, the CPU 90 uses the RAM 91 as a working memory and operates in accordance with a control program recorded in the ROM 92 while properly referring to, for example, various parameters of individual units recorded in the NV-RAM 99 constituted of a nonvolatile memory.

Now, the action exerted on the objective lens unit 74 driven through the actuators 71 and 72 of the driving force generation circuits 51 and 52 will be described based on FIG. 2. Further, the description will be given assuming that in FIG. 2, a straight line connecting (starting points of) the above driven positions P1 and P2 and the above optical axis s1 intersect at 900 and the position of the center of mass G of the objective lens unit 74 (holding the objective lens 70) exists in the straight line connecting the driven positions P1 and P2.

Namely, as shown in FIG. 3, by supplying drive signal currents i1 and i2 to the coils 53 and 54 of the first and second actuators 71 and 72, respectively, as shown in FIG. 2, driving forces (Lorentz forces) f1 and f2 in a direction parallel to the focusing direction y along the optical axis s1 of the objective lens 70 on the optical head 65 are generated immediately above the driven positions P1 and P2 on the two actuators 71 and 72. Consequently, as described above, it becomes possible to drive the objective lens unit 74 in the focusing direction y and the tilt direction θ. The relations between the drive signal currents i1 and i2 and the driving forces f1 and f2 are given by the following expressions:

f1=H1×i1

f2=H2×i2

where H1 and H2 are constants determined by the physical property of the optical head 65.

Further, in the optical head 65 of this embodiment, respective distances from the driven positions P1 and P2 to which the driving forces f1 and f2 are applied by the actuators 71 and 72 to the position of the center of mass G of the objective lens unit 74 is allowed to be separation distances a and b different from each other for a reason described in detail later. Here, when drive currents with the same current value and the same polarity are supplied to the first and second actuators 71 and 72, respectively, the angle in the tilt direction θ is set to 0°. In this case, the following relation is satisfied.

H1×a=H2×b

The optical head 65 is generally designed to satisfy this relation, so that as the above drive current circuits 97 and 98 supplying the drive currents to the actuators 71 and 72, those having the same characteristic can be used. Further, as shown in FIG. 3, the focus/tilt control circuit 87 includes a tilt control circuit 877, and this tilt control circuit 877 outputs the tilt drive signal (tilt drive command value voltage) with a value corresponding to a tilt amount between the information recording surface 100a of the optical disk 100 rotationally driven by the spindle motor 63 and the optical axis of the objective lens 70 on the optical head 65. Here, for example, a tilt sensor is provided on the optical head 65 of this embodiment, and a signal indicating the tilt amount between the information recording surface 100a of the optical disk 100 and the optical axis of the objective lens 70 on the optical head 65 is outputted from this tilt sensor. As shown in FIG. 1 and FIG. 3, the CPU 90 supplies the signal outputted from this tilt sensor as the tilt error signal to the tilt control circuit 877. The tilt control circuit 877 generates the above tilt drive signal based on this tilt error signal. Namely, by supplying a drive current corresponding to the thus obtained tilt drive signal to each of the actuators 71 and 72, the tilt of the objective lens 70 on the optical head 65 can be corrected.

Here, in an optical head of the above Patent Document 2 (Japanese Patent Application Laid-open No. 2003-272203) including a tilt actuator mechanism using two focus coils, driving currents i1 and i2 supplied to the two focus coils satisfy the following relations.

i1=if−it

i2=if+it

It is possible to perform focus drive by the above drive current “if” and perform tilt drive by the drive current “it”. When the method of Patent Document 2 is applied in the structure of FIG. 2, the resultant moment in the tilt direction θ establishes the following relation.

$$\begin{matrix}- f 1 \times a + f 2 \times b = ( - H 1 \times a \times i 1 + H 2 \times b \times i 2 ) \times cos θ \\ = ( - H 1 \times a \times ( if - it ) + H 1 \times a \times ( if + it ) ) \times cos θ \\ = ( 2 \times H 1 \times a \times cos θ ) \times it \\ = ( 2 \times H 2 \times b \times cos θ ) \times it\end{matrix}$$

It is found that the objective lens (objective lens unit) can be driven in the tilt direction by the above “it”. However, when the supply control of the drive currents is applied to the optical head 65 of this embodiment, the following relation is also established at the same time since the respective distances from the position of the center of mass G of the objective lens unit 74 to the driven positions P1 and P2 to which the driving forces f1 and f2 are applied are the separation distances a and b different from each other, and the resultant force in the focusing direction y is given by the following expression.

$$\begin{matrix}f 1 + f 2 = H 1 \times ( if - it ) + H 2 \times ( if + it ) \\ = H 1 \times ( if - it ) + H 1 \times ( if + it ) \times a / b \\ = H 1 \times ( 1 + a / b ) \times if - H 1 \times ( 1 - a / b ) \times it \\ = H 2 \times ( 1 + b / a ) \times if - H 2 \times ( 1 - b / a ) \times it\end{matrix}$$

From the above expression, it is found that in driving the objective lens 70 (objective lens unit 74) in the focusing direction y, the drive current “it” to drive the objective lens 70 in the tilt direction θ is interfering. Namely, the focus control and the tilt control cannot be drive-controlled independently of each other. Hence, for example, if the tilt control by the method of Patent Document 2 is performed under focus control, the control performance of the focus servo deteriorates, and consequently the occurrence of a problem that the changes in the reflected light from the pits and the like formed on the tracks of the optical disk 100 cannot be normally reflected and thereby the signal is not normally supplied to the data reproduction circuit 78 is expected.

Hence, in the optical disk device 1 of this embodiment, in consideration of the above problem of interference in the focus drive caused by the tilt drive, the focus drive and the tilt drive are performed independently in a feedforward manner based on the above relation between the separation distances a and b which is previously acquired, for example, by measuring the design size of the objective lens unit 74 of the body of the optical head 65 and the actual size of the body of the objective lens unit 74. That is to say, in the optical head 65 with the structure of FIG. 2, values obtained by allocating the drive current “it” acting on the control in the tilt direction θ at a ratio of 1/b:1/a and further adding this drive current “it” of opposite signs (opposite polarities) to the drive current “if” acting on the control in the focusing direction y are used as the drive currents i1 and i2 of the first and second actuators 71 and 72 so that a possible influence of a displacement force in the tilt direction θ on a displacement force in the focusing direction y at the position of the center of mass G when the displacement forces in the tilt direction θ and the forcing direction y act on the objective lens unit 74 is avoided. Here, when attention is focused only on the drive current “it”, by supplying the drive current “it” allocated in the above ratio to the first and second actuators 71 and 72, moments with respect to the position of the center of mass G produced respectively at the driven positions P1 and P2 by the allocated drive current “it” become equal to each other. The above drive currents i1 and i2 thus allocated can be represented by the following expressions [1] and [2].

i1=(if−it/b) expression [1]

i2=(if+it/a) expression [2]

Here, the resultant moment in the tilt direction θ acting on the objective lens unit 74 in this case satisfies the following relation.

$$\begin{matrix}- f 1 \times a + f 2 \times b = ( - H 1 \times a \times i 1 + H 2 \times b \times i 2 ) \times cos θ \\ = ( - H 1 \times a \times ( if - it / b ) + \\ H 1 \times a \times ( if + it / a ) ) \times cos θ \\ = H 1 \times ( 1 + a / b ) \times it \times cos θ \\ = H 2 \times ( 1 + b / a ) \times it \times cos θ\end{matrix} \qquad \begin{matrix}\begin{matrix}\begin{matrix} \\ \end{matrix} \\ expression [ 3 ]\end{matrix} \\ expression [ 4 ]\end{matrix}$$

Further, the resultant force in the focusing direction y acting on the objective lens unit 74 is given by the following expressions.

$$\begin{matrix}f 1 + f 2 = H 1 \times i 1 + H 2 \times i 2 \\ = H 1 \times ( if - it / b ) + H 1 \times ( if + it / a ) \times a / b \\ = H 1 \times ( 1 + a / b ) \times if \\ = H 2 \times ( 1 + b / a ) \times if\end{matrix} \qquad \begin{matrix} \\ \\ expression [ 5 ] \\ expression [ 6 ]\end{matrix}$$

That is to say, the tilt control of the objective lens unit 74 and the focus control of the objective lens unit 74 are performed by the drive current “it” as shown in expression [3] and expression [4] and by the drive current “if” as shown in expression [5] and expression [6], respectively, independently of each other. Further, by supplying currents in the same direction and with the same magnitude to the actuators 71 and 72 to measure the displacement in the focusing direction y, a current drive amount sensitivity a [m/A] being the ratio of the displacement in the focusing direction y to the supplied current can be acquired. Further, by the above current drive amount sensitivity a, a stiffness Kb in the focusing direction y of the elastic supporting member 59 on the optical head 65 shown in FIG. 2, and the separation distances a and b from the position of the center of mass G to the driven positions P1 and P2, the drive currents i1 and i2 and the driving forces f1 and f2 of the actuators 71 and 72 satisfy the relation of the following expression [7].

f1=Kb×α×b×i1/(a+b),

f2=Kb×αa×i2/(a+b) expression [7]

From this relation, for example, when the angle in the tilt direction θ is very small, the drive currents i1 and i2 to be supplied to the actuators 71 and 72 can be determined as shown in the following expression [8] if the value of the drive current in the focusing direction is related to a driving force F [N] and the value of the drive current in the tilt direction is related to the value of a drive torque T [Nm].

i1={1/(kb×α)}{F−(T/b)},

i2={1/(kb×α)}{F+(T/a)} expression [8]

In the above example, the case where the drive signal “it” in the tilt direction is multiplied by 1/b and 1/a and added with signs opposite to each other to the drive current in the focusing direction has been described, but in this aspect, the allocation ratio is only required to be 1/b:1/a, so that also in the case of equivalent ratios such as a:b, a/(a+b):b/(a+b), k×a:a×b (k: a constant other than 0), the tilt drive and the focus drive can be performed independently by “it” and “if” in a like manner. Anyway, the multiplier by which the drive signal current contributing to the tilt drive is finally outputted is only required to be determined according to specifications required for the drive current circuits 97 and 98 and the optical head 65.

Based on the above point, the focus/tilt control circuit 87 according to the optical disk device 1 of this embodiment is configured as follows. Namely, as shown in FIG. 3, the focus/tilt control circuit 87 includes a focus control circuit 870, the tilt control circuit 877, an adder (to be precise, a subtracter) 873 and an adder 874 functioning as a drive signal synthesis circuit, and amplifiers (AMP) 871, 872, 875, and 876. The focus control circuit 870 generates a focus drive command value voltage Vf which becomes the drive signal (focus drive signal) in the focusing direction y of the objective lens unit 74 on the optical head 65 based on the focus error signal outputted from the RF amplifier 85.

The amplifier 871 and the amplifier 872 amplify a tilt drive command value voltage Vt as the tilt drive signal outputted from the tilt control circuit 877. The ratio of amplification factors of the amplifier 871 and the amplifier 872 is determined to be 1/b:1/a in association with the separation distances a and b from the position of the center of mass G of the objective lens unit 74 to the first and second driven positions P1 and P2 to which the drive forces f1 and f2 of the actuators 71 and 72 are applied. To put it more concretely, as an example, the amplification factor of the amplifier 871 is 1/b, and the amplifier factor of the amplifier 872 is 1/a. Namely, these amplifiers 871 and 872 function as a driving force adjustment section which adjusts the allocation of the driving forces f1 and f2 to be applied to the driven positions P1 and P2 by the actuators 71 and 72 (of the driving force generation circuits 51 and 52) so that the possible influence of the displacement force in the tilt direction θ on the displacement force in the focusing direction y at the position of the center of mass G when the displacement forces in the tilt direction θ and the forcing direction y act on the objective lens unit 74 is avoided.

Here, it is also possible to previously store the separation distance values a and b, for example, as information inherent in the optical head 65 in addition to the information representing the above expression [1] and expression [2] in the NV-RAM 99 or the like and apply variable gain amplifiers to the amplifiers 871 and 872. That is to say, it is also possible that the CPU 90 refers to the information of expression [1] and expression [2] and the information indicating the separation distance values a and b stored in the NV-RAM 99 when the objective lens unit 74 is drive-controlled and properly sets the ratio of amplification factors of the two variable gain amplifiers.

Further, as shown in FIG. 3, the adder 873 adds an output voltage of the amplifier 871 with its sign reversed to the focus drive command value voltage Vf outputted from the focus control circuit 870 (subtracts the output voltage of the addition amplifier 871). Furthermore, the adder 874 adds an output voltage of the amplifier 872 to the focus drive command value voltage Vf outputted from the focus control circuit 870.

Moreover, amplification factors of the amplifiers 875 and 876 are set, for example, according to the range and resolution of the tilt drive command value voltage Vt outputted from the tilt control circuit 877, specifications of the drive current circuits 97 and 98 which drive the actuators 71 and 72, drive precisions required for the actuators 71 and 72, and so on.

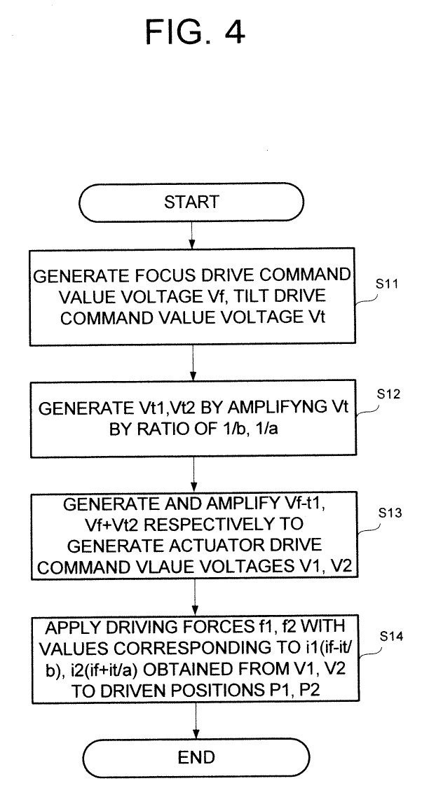

Next, control to apply the driving forces f1 and f2, the allocation of which is adjusted, to the first and second driven positions P1 and P2 on the objective lens unit 74 performed by the optical disk device 1 of this embodiment configured as above will be described based on FIG. 4. FIG. 4 is a flowchart showing processing performed in the focus/tilt control circuit 87 and the first and second driving force generation circuits 51 and 52.

As shown in FIG. 2 to FIG. 4, first, the focus/tilt control circuit 87 sets driving forces before allocation adjustment as a basis of the application to the drive positions P1 and P2 on the objective lens unit 74, that is, generates drive signals corresponding to driving forces before allocation. In this case, the focus control circuit 870 generates (outputs) the focus drive command value voltage Vf based on the focus error signal, while the tilt control circuit 877 generates (outputs) the tilt drive command value voltage Vt based on the tilt error signal (S[step] 11).

Then, the amplifier 871 and the amplifier 872 respectively output tilt drive command values Vt1 and Vt2 obtained by making the amplification factors of the inputted tilt drive command value Vt different from each other as a process to adjust the allocation of the driving forces f1 and f2 respectively to be applied to the first and second driven positions P1 and P2 so that the possible influence of the displacement force in the tilt direction θ on the displacement force in the focusing direction y at the position of the center of mass G when the displacement forces in the tilt direction θ and the forcing direction y act on the objective lens unit 74 is avoided. Namely, the amplifier 871 outputs the tilt drive command value Vt1 obtained by amplifying the tilt drive command value voltage Vt by 1/b, while the amplifier 872 outputs the tilt drive command value Vt2 obtained by amplifying the tilt drive command value voltage Vt by 1/a (S12).

Further, as shown in FIG. 3 and FIG. 4, the adder 873 adds the tilt drive command value Vt1 outputted from the amplifier 871 with its sign reversed to the focus drive command value voltage Vf outputted from the focus control circuit 870. On the other hand, the adder 874 adds the tilt drive command value Vt2 outputted from the amplifier 872 to the focus drive command value voltage Vf outputted from the focus control circuit 870. The amplifiers 875 and 876 amplify the voltages inputted from the adders 873 and 874 sides to generate actuator drive command value voltages V1 and V2 (S13), and supply them to the first and second drive current circuits 97 and 98. The drive current circuits 97 and 98 output the drive currents i1=if−it/b and i2=if +it/a corresponding to the supplied actuator drive command value voltages V1 and V2 to the magnetic circuits 57 and 58 (coils 53 and 54). As shown in FIG. 2, the first and second actuators 71 and 72 including the magnetic circuits 57 and 58 (coils 53 and 54) apply the driving forces f1 and f2, the allocation of which is adjusted and which are generated corresponding to the drive currents i1 and i2, to the first and second driven positions P1 and P2 of the objective lens unit 74, respectively (S14).

Hence, the tilt control of the objective lens unit 74 and the focus control of the objective lens unit 74 are performed by the drive current “it” as shown in expression [3] and expression [4] and by the drive current “if” as shown in expression [5] and expression [6], respectively, independently of each other. Accordingly, in the optical disk device 1 including the optical head 65 of this embodiment, the suitable drive control of the objective lens 70 can be realized while the mutual interference between the tilt control and the focus control of the objective lens 70 on the optical head 65 is suppressed.

Further, in the optical disk device 1 of this embodiment, as described above, the respective distances from the driven positions P1 and P2 at which the driving forces f1 and f2 of the actuators 71 and 72 are generated to the position of the center of mass G of the optical head 65 are allowed to be the separation distances a and b different from each other. Accordingly, the flexibility of the layout of components of the optical head 65 increases, which makes it possible to obtain the mechanically and optically optimally designed optical head 65.

### Second Embodiment

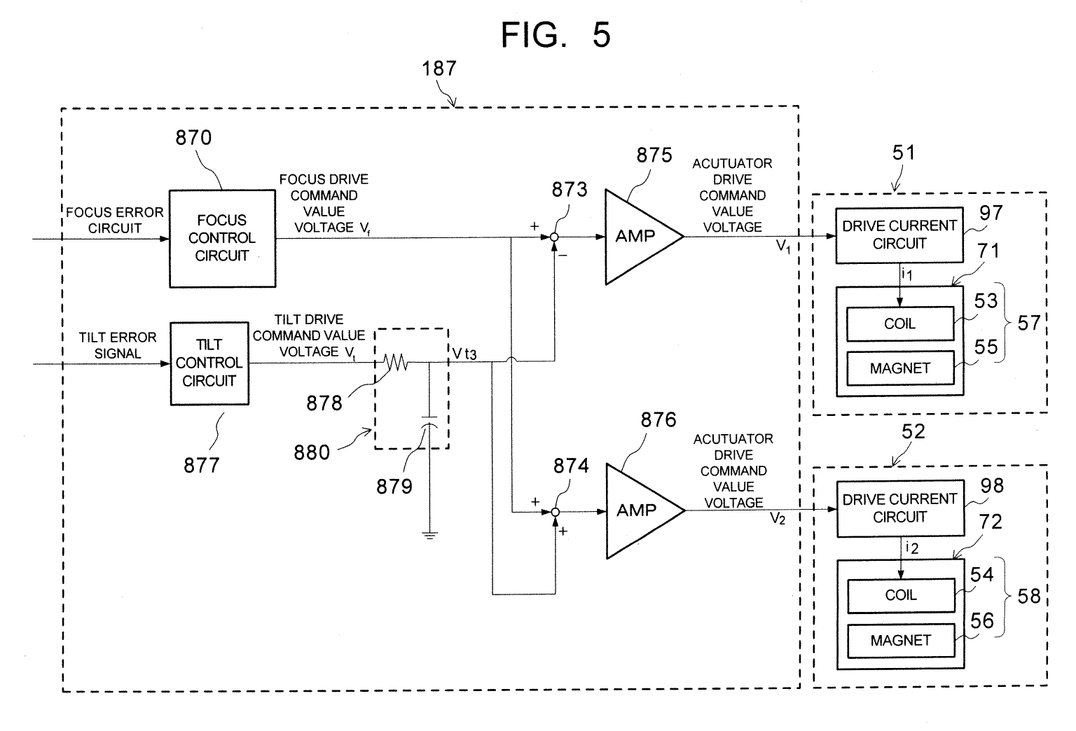

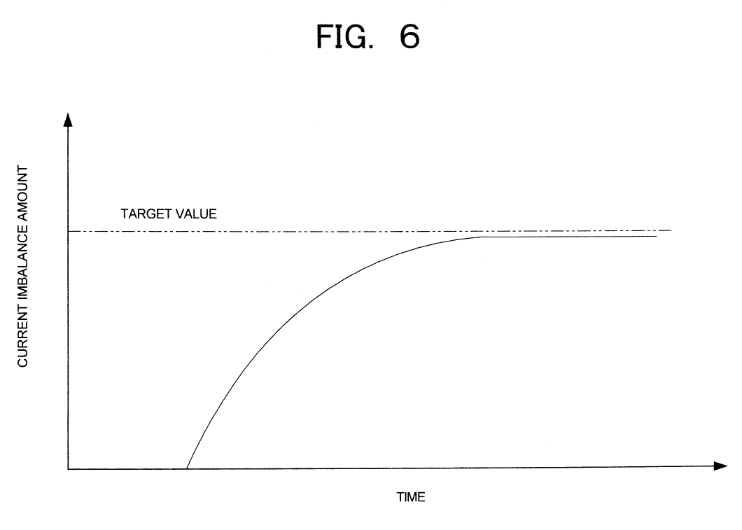

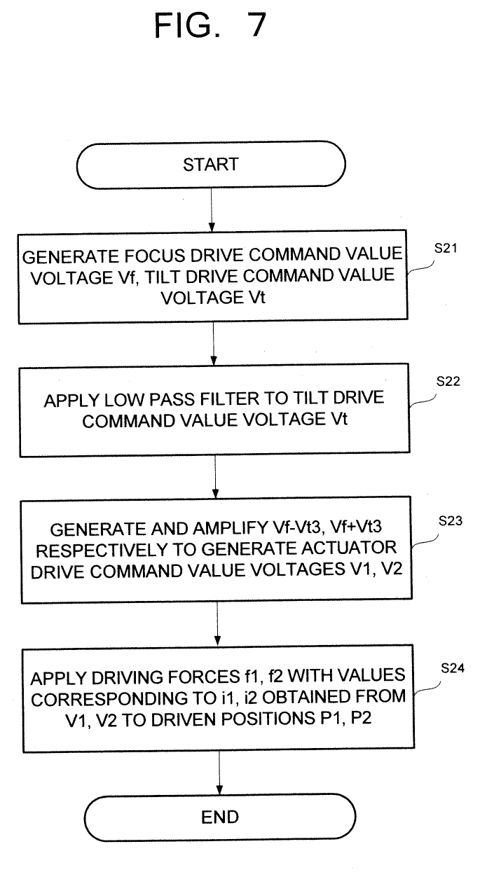

Next, a second embodiment of the present invention will be described based on FIG. 5 to FIG. 7. Here, FIG. 5 is a block diagram functionally showing the configurations of a focus/tilt control circuit 187 and the above first and second driving force generation circuits 51 and 52 included in an optical disk device of this embodiment. Further, FIG. 6 is a graph showing the transition of a current imbalance amount between the drive currents i1 and i2 respectively outputted from the first and second drive current circuits 97 and 98 included in the optical disk device of this embodiment. Furthermore, FIG. 7 is a flowchart showing processing performed in the focus/tilt control circuit 187 and the first and second driving force generation circuits 51 and 52. Incidentally, in this embodiment, the description will be given by applying FIG. 1 to FIG. 4 referred to in the first embodiment thereto, and in the above FIG. 5 to FIG. 7, mainly the same numerals and symbols and names will be used to designate the same components as those used in the optical disk device 1 of the first embodiment shown in FIG. 1 to FIG. 4, and a description thereof will be omitted.

Namely, as shown in FIG. 5, the optical disk device of this embodiment includes the focus/tilt control circuit 187 instead of the focus/tilt control circuit 87 included in the optical disk device 1 of the first embodiment. The focus/tilt control circuit 187 includes a low-pass filter 880 constituted of a resistance 878 and a capacitance (capacitor) 878 instead of the amplifiers 871 and 872 of the focus/tilt control circuit 87 of the first embodiment.

In this embodiment, as shown in FIG. 6, the low-pass filter 880 functions as a rate-of-change reduction circuit which reduces the rate of change with time of the value of the tilt drive command value voltage Vt outputted from the tilt control circuit 877. The tilt drive command value voltage which is converted into a signal whose amount of change with time is small by the low-pass filter 880 is applied to the drive current circuits 97 and 98 via the amplifiers 875 and 876. As a result, the change with time of a difference i2-i1 (current imbalance amount) between the drive currents supplied to the actuators 71 and 72 becomes smooth as shown in FIG. 6.

That is to say, in the focus/tilt control circuit 187, almost the same processing as that shown in FIG. 4 is performed. More specifically, as shown in FIG. 7, in the process of performing processing from S(step) 21 to S24, the low-pass filter is applied to the tilt drive command value voltage Vt outputted from the tilt control circuit 877 to reduce the rate of change with time of the value of the tilt drive command value voltage Vt (S22). Further, a tilt drive command value voltage Vt3 whose rate of change is reduced by the low-pass filter 880 is added to the focus drive command value voltage Vf outputted from the focus control circuit 870 by the adders 873 and 874, and further the actuator drive command value voltages V1 and V2 obtained by amplifying the added (synthesized) drive command value voltages by the amplifiers 875 and 876 are outputted to the first and second driving force generation circuits 51 and 52 sides, respectively, as shown in FIG. 5 (S23).

Accordingly, in the optical disk device 1 according to this embodiment, in a state where focus control is performed so that the laser light is focused onto the information recording surface 100a of the optical disk 100, the optical head 65 is driven and controlled in the tilt direction θ without rapidly changing the difference i2−i1 (current imbalance amount) between the drive currents of the actuators 71 and 72. Namely, the actuator drive command values V1 and V2 are allocated by the focus/tilt control circuit 187 so that the displacement force in the tilt direction θ does not act rapidly. The influence of unexpected disturbance force in the focusing direction caused by the tilt drive is avoided by such control. For example, it is prevented that the unexpected disturbance force caused by the tilt drive is added to a focus control system and thereby the focus control goes wrong. Note, however, that this embodiment is intended to practically remove the influence on the focus control system caused by the rapid tilt drive with respect to the focus control. In a case where a factor behind the deterioration in performance such as a steady-state deviation of the focus control system caused by non-rapid tilt drive reaches a practically unacceptable range, a later-described third embodiment is used.

### Third Embodiment

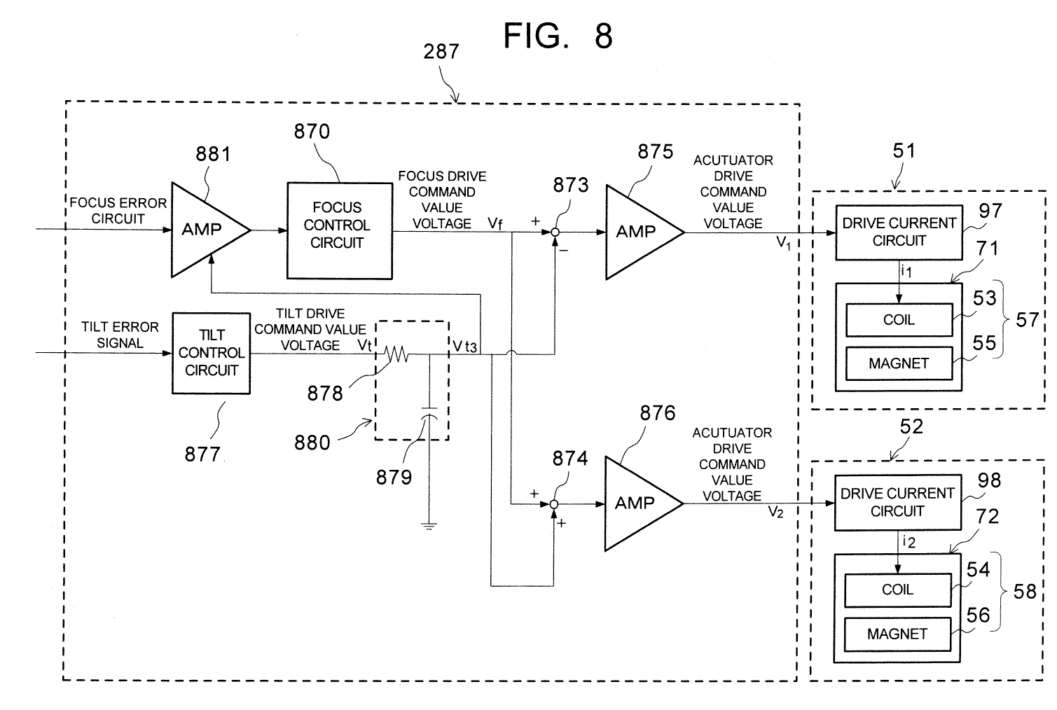

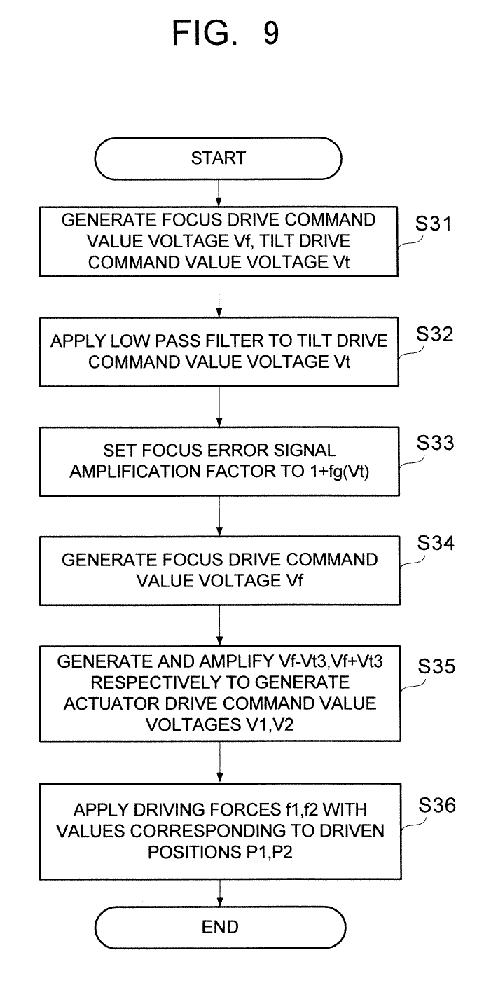

Next, a third embodiment of the present invention will be described based on FIG. 8 and FIG. 9. Here, FIG. 8 is a block diagram functionally showing the configurations of a focus/tilt control circuit 287 and the above first and second driving force generation circuits 51 and 52 included in an optical disk device of this embodiment. Further, FIG. 9 is a flowchart showing processing performed in the focus/tilt control circuit 287 and the first and second driving force generation circuits 51 and 52. Incidentally, in this embodiment, the description will be given by applying FIG. 1 to FIG. 7 referred to in the first and second embodiments thereto, and in the above FIG. 8 and FIG. 9, mainly the same numerals and symbols and names will be used to designate the same components as those used in the optical disk devices of the first and second embodiments shown in FIG. 1 to FIG. 7, and a description thereof will be omitted.

Further, as shown in FIG. 8, the optical disk device of this embodiment includes the focus/tilt control circuit 287 instead of the focus/tilt control circuit 187 included in the optical disk device of the second embodiment. The focus/tilt control circuit 287 further includes a variable gain amplifier (AMP) 881 in addition to the components of the focus/tilt control circuit 187.

Namely, the above variable gain amplifier 881 functions, under the control of the CPU 90, as a gain variable circuit which varies the gain of the focus error signal inputted to the focus control circuit 870 in association with the rate of change with time of the value of the tilt drive command value voltage reduced by the low-pass filter 880. As this variable gain amplifier 881, the one whose amplification factor is multiplied by 1+fg (Vti) by a nonnegative function fg (Vti) such as satisfies the tilt drive command value voltage Vt and a desired control specification is used. That is to say, in a situation where the amount of change with time of the tilt drive command value voltage is reduced by the low-pass filter 880, the variable gain amplifier 881 increases the gain of the focus error signal when the absolute amount of the above current imbalance amount increases to thereby improve error suppression of the focus control. Consequently, the possible influence of the displacement force in the tilt direction θ on the focus control at the position of the center of mass G whose change with time is not rapid in the above second embodiment is also avoided. For example, the steady-state deviation is reduced.

In the focus/tilt control circuit 287, almost the same processing as that shown in FIG. 7 is performed. More specifically, as shown in FIG. 9, in the process of performing processing from S(step) 31 to S36, the low-pass filter is applied to the tilt drive command value voltage Vt outputted from the tilt control circuit 877 to reduce the rate of change with time of the value of the tilt drive command value voltage Vt (S32). The gain of the focus error signal inputted to the focus control circuit 870 is varied in association with the rate of change with time of the value of the tilt drive command value voltage reduced by the low-pass filter 880. More specifically, the amplification factor of the variable gain amplifier 881 is set to 1+fg (Vt) using the nonnegative function fg (Vt) designed to satisfy the tilt drive command value voltage after passing through the low-pass filter 880 and a desired performance (S33). Based on this amplification factor of the variable gain amplifier 881, the focus error signal is amplified, so that the focus drive command value voltage Vf which changes the degree of suppressing the error in the focusing direction is obtained (S34). Further, the tilt drive command value voltage Vt3 whose rate of change is reduced by the low-pass filter 880 is added to the focus drive command value voltage Vf obtained based on the focus error signal whose gain is varied and outputted by the focus control circuit 870 by the adders 873 and 874, and further the actuator drive command value voltages V1 and V2 obtained by amplifying the added (synthesized) drive command value voltages by the amplifiers 875 and 876 are outputted to the first and second driving force generation circuits 51 and 52 sides, respectively, as shown in FIG. 8 (S35).

Hence, according to the optical disk device including the focus/tilt control circuit 287 of this embodiment, it becomes possible to increase the gain of the focus tilt error signal when the absolute amount of the above current imbalance amount increases (when the controlling force in the tilt direction is high) in the situation where the amount of change with time of the tilt drive command value voltage is reduced, so that the sensitivity of the focus control is improved, which can realize suitable drive control of the objective lens 70.

### Fourth Embodiment

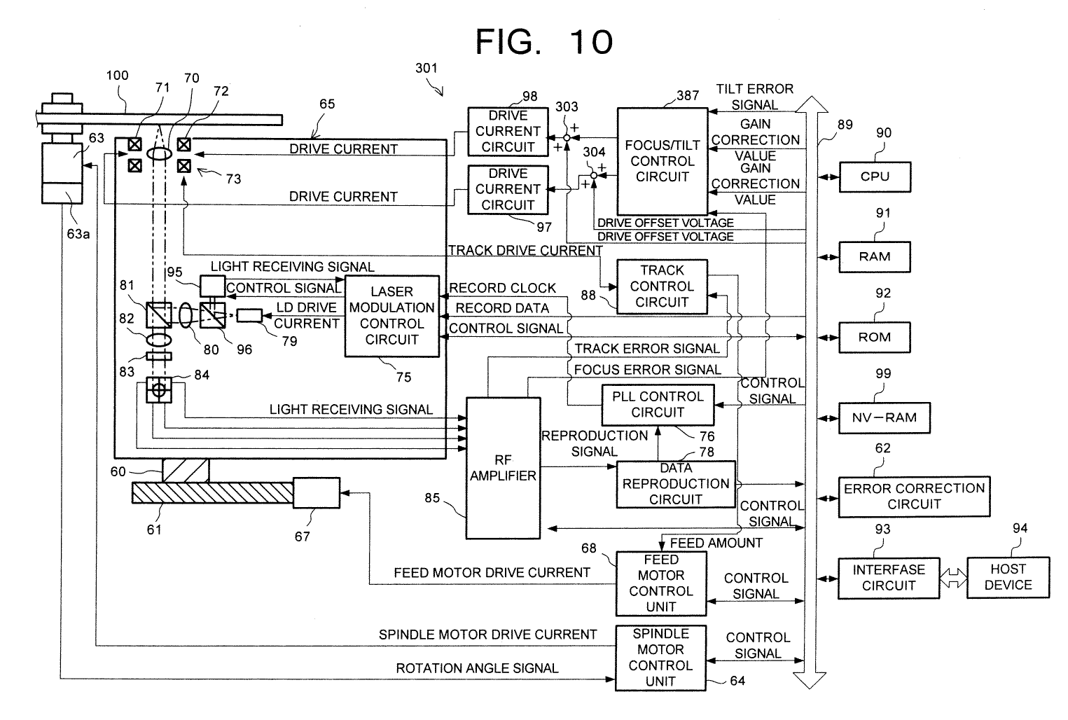

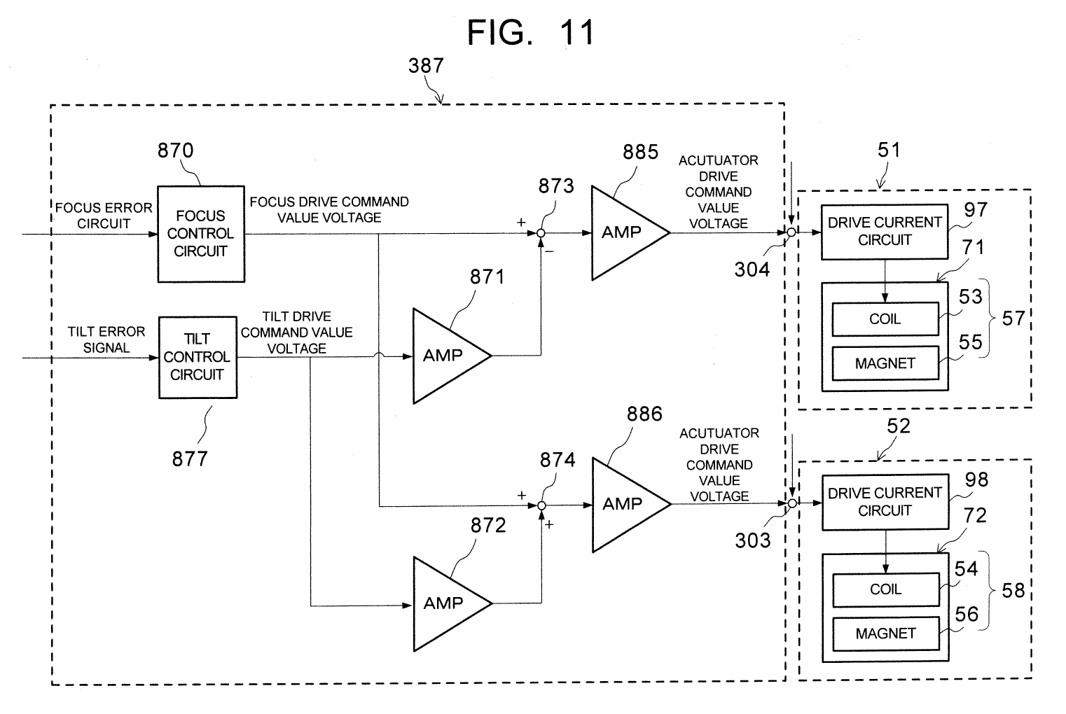

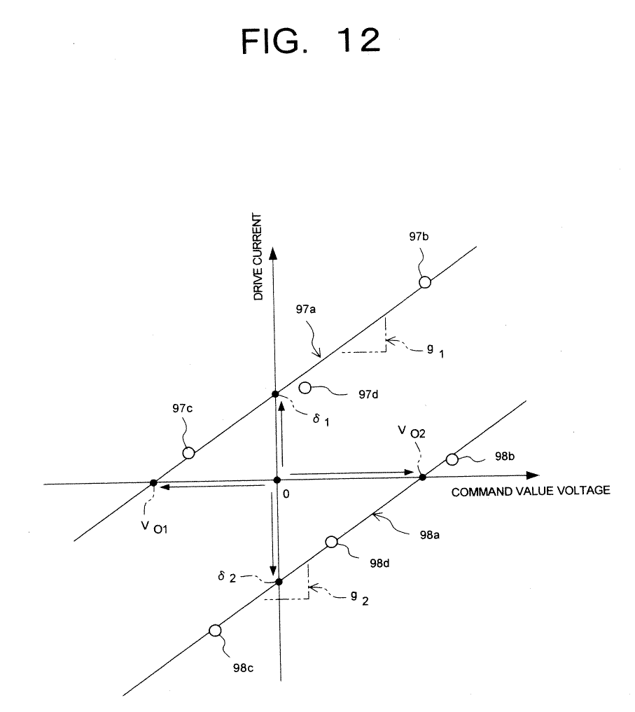

Next, a fourth embodiment of the present invention will be described based on FIG. 10 to FIG. 15. Here, FIG. 10 is a block diagram functionally showing the configuration of an optical disk device 301 according to this embodiment. Further, FIG. 11 is a block diagram functionally showing the configurations of a focus/tilt control circuit 387 and the above first and second driving force generation circuits 51 and 52 included in the optical disk device 301 of this embodiment. Furthermore, FIG. 12 is a diagram to explain measurement items of characteristic parameters of the drive current circuits 97 and 98 included in the optical disk device 301.

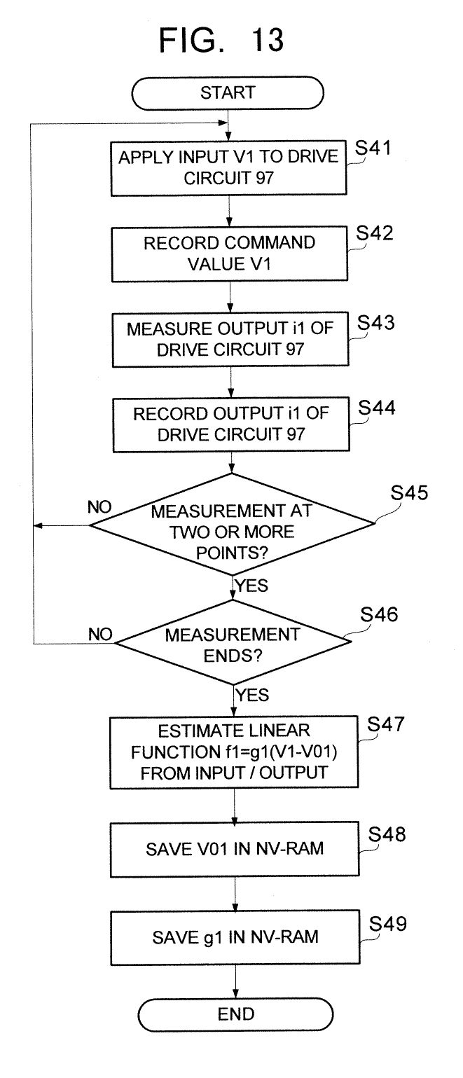

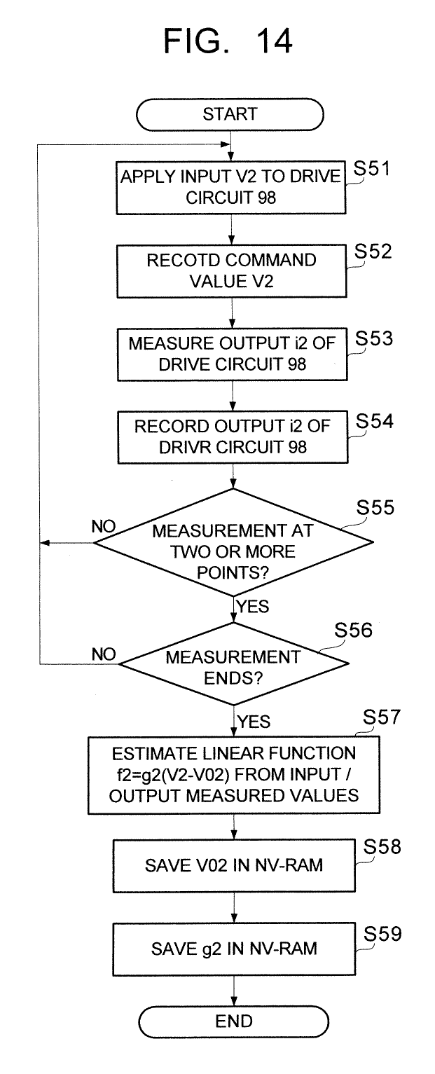

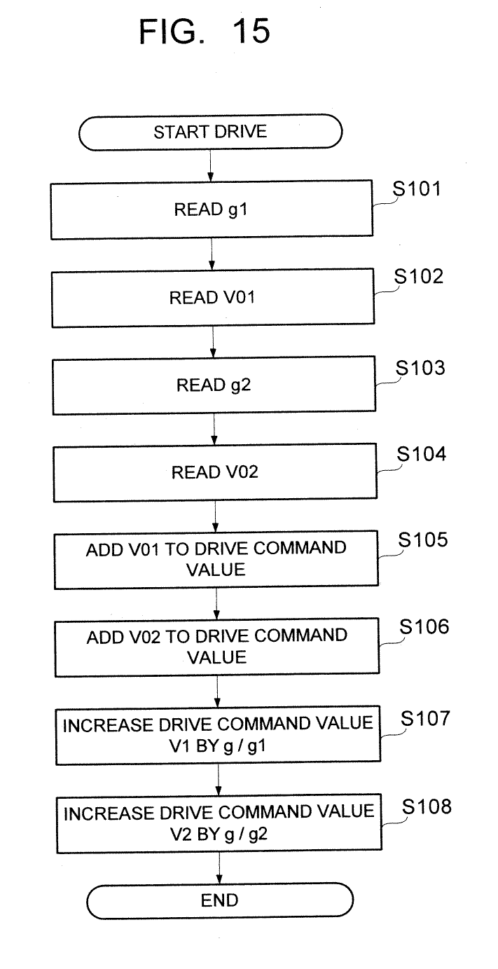

Further, FIG. 13 is a flowchart showing processing on measurement of a characteristic of the first drive current circuit 97 included in the optical disk device 301 and registration of results of the measurement, and FIG. 14 is a flowchart showing processing on measurement of a characteristic of the second drive current circuit 98 included in the optical disk device 301 and registration of results of the measurement. Furthermore, FIG. 15 is a flowchart showing operation control to correct the characteristics of the first and second drive current circuits when the optical disk device 301 is used. Incidentally, in this embodiment, the description will be given by applying FIG. 1 to FIG. 9 referred to in the first to third embodiments thereto, and in the above FIG. 10 to FIG. 15, the same numerals and symbols and names will be used to designate the same components as those used in the optical disk devices of the first to third embodiments shown in FIG. 1 to FIG. 9, and a description thereof will be omitted.

Namely, as shown in FIG. 11, the optical disk device 301 according to this embodiment includes the focus/tilt control circuit 387 instead of the focus/tilt control circuit included in the optical disk device 1 of any one of the first to third embodiments, and further includes adders 303 and 304. The focus/tilt control circuit 387 includes variable gain amplifiers (AMP) 885 and 886 instead of the amplifiers 875 and 876 of the focus/tilt control circuit of any one of the first to third embodiments.

Here, in the optical disk device 301 according to this embodiment, the drive currents i1 and i2 are supplied to the first and second actuators 71 and 72 so that the possible influence of the displacement force in the tilt direction θ on the displacement force in the focusing direction y at the position of the center of mass G when the displacement forces in the tilt direction θ and the forcing direction y act on the objective lens unit 74 is avoided.

Moreover, as described above, in the first and second driving force generation circuits 51 and 52, as shown in FIG. 10 and FIG. 11, the first and second drive current circuits 97 and 98 output the drive currents i1 and i2 with values corresponding to the voltage values (actuator drive command value voltages V1 and V2) of the inputted signals. Further, as shown in FIG. 2, the first and second actuators 71 and 72 generate the driving forces f1 and f2 corresponding to the values of the drive currents i1 and i2 respectively outputted from the first and second drive current circuits 97 and 98.

Further, in this embodiment, characteristic parameters inherent in the respective drive current circuits indicating the correspondences between the voltage values of the signals respectively inputted to the first and second drive current circuits 97 and 98 and the values of the drive currents generated by the inputs of the signals with these voltage values are stored, for example, in the NV-RAM 99 as a storage section, for example, when the optical disk device 301 is manufactured. Furthermore, the CPU 90 reads the values of the characteristic parameters stored in the NV-RAM 99 when the optical disk device 301 is used (recorded/reproduced), as shown in FIG. 10 and FIG. 11, the gains of the variable gain amplifiers 885 and 886 are set to amplification factors corresponding to the read values, and the values of the characteristic parameters are added through the adders 303 and 304 to the actuator device command value voltages V1 and V2 whose values are amplified by the variable gain amplifiers 885 and 886. Consequently, the CPU 90 substantially adjusts the allocation of the driving forces f1 and f2 practically to be applied to the driven positions P1 and P2 of the objective lens unit 74, respectively, based on the above characteristic parameters.

Hereinafter, processing on measurement of concrete characteristic parameters and registration of results of the measurement will be described. Namely, in a method of eliminating a difference between an undesirable driving force offset due to electrical variations between the drive current circuits 97 and 98 supplying the drive currents i1 and i2 to the actuators 71 and 72 and a drive gain, first, as shown in FIG. 12, relations between the drive command value voltages applied to the respective drive current circuits 97 and 98 and the drive currents are investigated at two or more points (investigated at 97b to 98d and 98b to 98d), and input-output relations of the respective drive current circuit 97 and 98 are estimated by linear functions. Subsequently, offset voltages corresponding to a drive signal current 0 [A] and drive gains corresponding to the slopes of the linear functions are measured from the linear functions and stored as parameters of the individual units in the NV-RAM 99 as the nonvolatile memory. Then, at the stage of using the product, drive gains g1 and g2 (slopes) of the respective drive current circuits 97 and 98 are corrected referring to the stored characteristic parameters, and offset voltages V01 and V02 (x-intercepts) corresponding to offsets δ1 and δ2 of the drive currents, respectively, are added to the actuator drive command value voltages V1 and V2.

Hence, first, as shown in FIG. 12 to FIG. 14, for example, when the optical disk device 301 is manufactured, in a state where the variable gain amplifiers 885 and 886 are set to have an equal amplification factor, for example, an amplification factor of 1.0, as shown in FIG. 13 and FIG. 14, the drive command value voltages are applied to the drive current circuits 97 and 98 (S41, S51), and these drive command value voltages V1 and V2 are recorded (S42, S52). Further, the drive current values i1 and i2 outputted from the drive current circuits 97 and 98 are measured (S43, S53), and the drive current values i1 and i2 at this time are recorded (S44, S54).

As shown in FIG. 12 to FIG. 14, in each of the drive current circuits 97 and 98, the measurement is performed at least two or more points (measurement points 97b to 97d to obtain a linear function 97a of the drive current circuit 97 and measurement points 98b to 98d to obtain a linear function 98a of the drive current circuit 98) (S45, S55), and performed a sufficient number of times (S46, S56). Then, input-output relations of the drive current circuits 97 and 98 of the respective actuators 71 and 72 are estimated by the linear functions f1 and f2 (S47, S57). Subsequently, the offset voltages V01 and V02 corresponding to the drive signal current 0 [A] and the drive gains g1 and g2 being the slopes of the above linear functions are measured, and these values are recorded as the parameters inherent in the units in the NV-RAM 99 (S48-S49, reverse order possible) (S58-S59, reverse order possible).

When the optical disk device 301 is used (when the optical disk 100 is recorded/reproduced), as shown in FIG. 10, FIG. 11, and FIG. 15, the CPU 90 properly refers to the offset voltages V01 and V02 and the drive gains g1 and g2 (S101-S104, random order possible), and the offset voltages V01 and V02 are applied from the CPU 90 to the drive current circuits 97 and 98 so that the offset between the driving forces is eliminated (S105-S106, reverse order possible). Further, the CPU 90 changes the amplification factors of the variable gain amplifiers 885 and 886 by supplying gain correction values such that the drive gain difference between the drive current circuits 97 and 98 is eliminated. For example, when the target value of the drive gain is g, it is only necessary to multiply the amplification factors of the variable gain amplifiers 885 and 886 by g/g1 and g/g2 (S107-S108, reverse order possible).

As described above, in this embodiment, by performing the above various adjustments, the difference in drive current offset and the difference in gain from the command value voltage to the drive current between the drive current circuits 97 and 98 can be eliminated. Incidentally, for example, by changing the amplifiers 875 and 876 of the focus/tilt control circuits 187 and 287 to variable gain amplifiers, the above correction of electric characteristics of the drive current circuits 97 and 98 can be also applied to the optical disk devices equipped with the focus/tilt control circuits 187 and 287.

While the present invention has been specifically described above using the respective embodiments, the present invention is by no means limited only to these embodiments and can be modified in various ways without departing from the spirit of the present invention. For example, the present invention is also applicable to a drive device to record/reproduce a magnetic optical disk such as a so-called MO in addition to the optical disk device to record/reproduce the optical disk.

It is to be understood that the present invention is not intended to be limited to the particular embodiments shown and described herein, but covers all such modifications as would fall within the scope of the following claims.

What is claimed is:

1. An optical disk device, comprising:
an objective lens unit having an objective lens and a lens holder, the objective lens and the lens holder being integrated;
an elastic supporting member supporting displaceably the objective lens unit on a body of an optical head;
first and second drive sections applying respectively driving forces to first and second driven positions on the objective lens unit opposed across a position of a center of mass of the objective lens unit supported by the elastic supporting member in a direction orthogonal to an optical axis of the objective lens; and
a driving force adjustment section adjusting allocation of the driving forces applied respectively to the first and second driven positions by the first and second drive sections so that a possible influence of a displacement force in a tilt direction on a displacement force in a focusing direction at the position of the center of mass when the displacement forces in the tilt direction and the focusing direction act on the objective lens unit is avoided.

2. The optical disk device according to claim 1,
wherein the driving force adjustment section adjusts the allocation of the driving forces based on a relation between respective separation distances from the position of the center of mass of the objective lens unit to the first and second driven positions.

3. The optical disk device according to claim 1,
wherein the first and second drive sections include first and second driving force generation circuits generating driving forces corresponding to values of inputted signals, respectively,
the optical disk device, further comprising:
a disk rotation drive section driving rotationally an optical disk;
a focus control circuit outputting a focus drive signal with a value corresponding to a correction amount to correct a positional displacement in the focusing direction between an information recording surface of the optical disk rotationally driven by the disk rotation drive section and a focus position of the objective lens on the optical head;
a tilt control circuit outputting a tilt drive signal with a value corresponding to a tilt amount between the information recording surface of the optical disk rotationally driven by the disk rotation drive section and the optical axis of the objective lens on the optical head;
a rate-of-change reduction circuit reducing a rate of change with time of the value of the tilt drive signal outputted from the tilt control circuit; and
a drive signal synthesis circuit adding the tilt drive signal whose rate of change is reduced by the rate-of-change reduction circuit to the focus drive signal outputted from the focus control circuit and outputting a resultant signal to each of sides of the first and second driving force generation circuits.

4. The optical disk device according to claim 1,
wherein the first and second drive sections include first and second driving force generation circuits generating driving forces corresponding to values of inputted signals, respectively, the optical disk device, further comprising:
a disk rotation drive section driving rotationally an optical disk;
a focus error signal output circuit outputting a focus error signal indicating a positional displacement in the focusing direction between an information recording surface of the optical disk rotationally driven by the disk rotation drive section and a focus position of the objective lens on the optical head;
a focus control circuit outputting a focus drive signal with a value corresponding to a correction amount to correct the positional displacement in the focusing direction based on the focus error signal inputted from a side of the focus error signal output circuit;
a tilt control circuit outputting a tilt drive signal with a value corresponding to a tilt amount between the information recording surface of the optical disk rotationally driven by the disk rotation drive section and the optical axis of the objective lens on the optical head;
a rate-of-change reduction circuit reducing a rate of change with time of the value of the tilt drive signal outputted from the tilt control circuit;
a drive signal synthesis circuit adding the tilt drive signal whose rate of change is reduced by the rate-of-change reduction circuit to the focus drive signal outputted from the focus control circuit and outputting a resultant signal to each of sides of the first and second driving force generation circuits; and
a gain variable circuit varying a gain of the focus error signal inputted to the focus control circuit in association with the rate of change with time of the value of the tilt drive signal reduced by the rate-of-change reduction circuit.

5. The optical disk device according to claim 1,
wherein the first and second drive sections include first and second driving force generation circuits including first and second drive current circuits outputting drive currents with values corresponding to voltage values of inputted signals, respectively, and include first and second driving force generation circuit caused to generate driving forces corresponding to the values of the driving currents outputted from the first and second drive current circuits, respectively,
the optical disk device further comprising a storage section storing characteristic parameters inherent in the respective drive current circuits indicating correspondences between the voltage values of the signals respectively inputted to the first and second drive current circuits and the values of the drive currents generated by the inputs of the signals with these voltage values,
wherein the driving force adjustment section adjusts the allocation of the driving forces based on the characteristic parameters stored in the storage section.

6. A control method of an optical disk device, comprising:
setting driving forces respectively to be applied to a first and second driven positions on an objective lens unit opposed across a position of a center of mass of the objective lens unit including an objective lens displaceably supported on a body of an optical head in a direction orthogonal to an optical axis of the objective lens;
adjusting allocation of the set driving forces so that a possible influence of a displacement force in a tilt direction on a displacement force in a focusing direction at the position of the center of mass when the displacement forces in the tilt direction and the forcing direction act is avoided; and
applying the driving forces the allocation of which is adjusted to the first and second driven positions, respectively.

7. The control method of the optical disk device according to claim 6,
wherein in adjusting the allocation of the driving forces, the allocation of the driving forces is adjusted based on a relation between respective separation distances from the position of the center of mass of the objective lens unit to the first and second driven positions.

8. The control method of the optical disk device according to claim 6,
wherein the optical disk device comprises:
first and second driving force generation circuits generating driving forces corresponding to values of inputted signals at the first and second driven positions, respectively;
a focus control circuit outputting a focus drive signal with a value corresponding to a correction amount to correct a positional displacement in the focusing direction between an information recording surface of a rotationally driven optical disk and a focus position of the objective lens on the optical head; and
a tilt control circuit outputting a tilt drive signal with a value corresponding to a tilt amount between the information recording surface of the rotationally driven optical disk and the optical axis of the objective lens on the optical head,
the control method further comprising:
reducing a rate of change with time of the value of the tilt drive signal outputted from the tilt control circuit; and
adding the tilt drive signal whose rate of change is reduced to the focus drive signal outputted from the focus control circuit and outputting a resultant signal to each of sides of the first and second driving force generation circuits.

9. The control method of the optical disk device according to claim 6,
wherein the optical disk device comprises:
first and second driving force generation circuits generating driving forces corresponding to values of inputted signals at the first and second driven positions, respectively;
a focus error signal output circuit outputting a focus error signal indicating a positional displacement in the focusing direction between an information recording surface of a rotationally driven optical disk and a focus position of the objective lens on the optical head;
a focus control circuit outputting a focus drive signal with a value corresponding to a correction amount to correct the positional displacement in the focusing direction based on the focus error signal inputted from a side of the focus error signal output circuit; and
a tilt control circuit outputting a tilt drive signal with a value corresponding to a tilt amount between the information recording surface of the rotationally driven optical disk and the optical axis of the objective lens on the optical head,
the control method further comprising:
reducing a rate of change with time of the value of the tilt drive signal outputted from the tilt control circuit;
varying a gain of the focus error signal inputted to the focus control circuit in association with the reduced rate of change with time of the value of the tilt drive signal;
making the focus control circuit output the focus drive signal with the value corresponding to the correction amount to correct the positional displacement in the focusing direction based on the focus error signal whose gain is varied; and
adding the tilt drive signal whose rate of change is reduced to the focus drive signal obtained based on the focus error signal whose gain is varied and outputted by the focus control signal and outputting a resultant signal to each of sides of the first and second driving force generation circuits.

10. The control method of the optical disk device according to claim 6,
wherein the optical disk device comprises:
first and second drive current circuits outputting drive currents with values corresponding to voltage values of inputted signals, respectively;
first and second driving force generation circuit caused to generate driving forces corresponding to the values of the drive currents outputted from the first and second drive current circuits, respectively;
a storage section storing characteristic parameters inherent in the respective drive current circuits indicating correspondences between the voltage values of the signals respectively inputted to the first and second drive current circuits and the values of the drive currents generated by the inputs of the signals with these voltage values, and
wherein in adjusting the driving forces, the allocation of the driving forces is adjusted based on the characteristic parameters stored in the storage section.
